(19) United States
(12) Patent Application Publication
(10) Pub. No.: US 2011/0296095 A1
(43) Pub. Date: Dec. 1, 2011

(54) DATA MOVEMENT ENGINE AND MEMORY CONTROL METHODS THEREOF

(75) Inventors: Haw-Kuen Su, Taipei City (TW); Jen-Fu Tsai, Hsinchu County (TW)

(73) Assignee: MEDIATEK INC., Hsin-Chu (TW)

(21) Appl. No.: 12/786,757

(22) Filed: May 25, 2010

(51) Int. Cl. G06F 12/02

(52) U.S. Cl. 711/105; 711/165; 711/E12.002; 711/E12.007

(57) ABSTRACT

A data movement engine (DME) for an electronic device is disclosed. The DME has an address generating module and a direct memory access (DMA) module. When the memory is switched to a lower power consumption state, a refresh area of a memory of the electronic device is refreshed and a non-refresh area of the memory is not refreshed. The address generating module obtains at least one source address of data in the non-refresh area, and generates at least one destination address for moving data from the non-refresh area to the refresh area and thereby a source-to-destination mapping table is generated. The DMA module performs a first data movement to move data from the non-refresh area to the refresh area according to the source-to-destination mapping table and independently of a microprocessor of the electronic device.

### BACKGROUND OF THE INVENTION

1. Field of the Invention

The present invention relates to electronic devices with at least one memory and particularly to devices controlling a power consumption state of the memory.

2. Description of the Related Art

Portable electronic devices are generally powered by batteries. In order to decrease power consumption, a portable electronic device may be switched from a normal mode to a lower power consumption mode, such as sleep mode, when idle for a while. The portable electronic device may leave the lower power consumption mode and switch to the normal mode when a resume event (for example, a user request) occurs.

In the normal mode, the components in the portable electronic device could be all powered on to provide computing or display capabilities. When the portable electronic device is in the lower power consumption mode, the idle components in the portable electronic device may be powered off or switched to a low powered state to reduce power consumption. However, to resume quickly, some programs and data should be stored in a memory, such as a DRAM (dynamic random access memory), a SRAM (static random access memory), a SDRAM (synchronous dynamic random access memory), a FLASH, etc, of the portable electronic device. In a case wherein the memory is a DRAM, the area the programs and data are stored will not be powered off and will be retained by DRAM refresh when the portable electronic device is in the lower power consumption mode. Besides DRAM, the microprocessor of the portable electronic device can neither be completely powered off, since it's the micro-processor to do the DRAM refresh. Thus, during the lower power consumption mode, the DRAM and the microprocessor take up a majority of the power consumption.

To reduce the power consumption of portable electronic devices during a lower power consumption mode, a self-refresh technique for the DRAM has been disclosed. When a DRAM is switched to a self-refresh state, the DRAM is mainly self-refreshed and minimally requires a corresponding microprocessor. The self-refresh technique considerably reduces power consumption during a lower power consumption mode.

A partial-array-self-refresh (PASR) technique is another low power technique for the DRAM. In comparison with the self-refresh technique which refreshes the entire DRAM periodically, the PASR technique only refreshes a portion of the DRAM to further reduce power consumption.

However, the PASR technique has some limitations. FIG. 1 depicts a DRAM 100 with continuous pages. The DRAM 100 is divided into a refresh area 102 and a non-refresh area 104. In a PASR state, the DRAM 100 only refreshes (self refresh) the refresh area 102 and does not maintain the data in the non-refresh area 104. Thus, if the refresh area has enough memory space and in order to achieve the better power consumption, data movement may be called to move data from the non-refresh area 104 to the refresh area 102 for switching the DRAM 100 to a PASR state. The data movement is conventionally accomplished by software. Thus, the microprocessor of the portable device still consumes a considerable amount of power before the DRAM is switched to the PASR state. Furthermore, because a kernel containing the data movement program is immovable during the data movement, the DRAM 100 is not allowed to be switched to the PASR state if the kernel is allocated in the non-refresh area 104, thus deeply hinders the possibility of the system employing the PASR technique. Furthermore, several look-up tables required during the data movement have to be stored in the refresh area 102. Thus, an additional software program is required to ensure the look-up tables are stored in the refresh area. Also, an extra software program is required when a resume event occurs, which recovers the DRAM to an original state before the prior data movement. The extra software programs affect the speed of switching the portable electronic device between the normal mode and the lower power consumption mode.

### BRIEF SUMMARY OF THE INVENTION

In one aspect, a data movement engine (DME) for an electronic device is disclosed. According to an exemplary embodiment of the electronic device, there are an address generating module and a direct memory access (DMA) module. The address generating module obtains at least one source address of data in a non-refresh area of a memory of the electronic device, and generates at least one destination address for moving data from the non-refresh area to a refresh area of the memory, wherein a source-to-destination mapping table is generated. When the memory is switched to a lower power consumption state, the refresh area is refreshed and the non-refresh area is not refreshed. The DMA module performs a first data movement to move data from the non-refresh area to the refresh area according to the source-to-destination mapping table and independently of a microprocessor of the electronic device.

From another aspect of the invention, a method of controlling a memory of an electronic device is disclosed. The method includes the following steps: obtaining at least one source address of data in a non-refresh area of the memory and generating at least one destination address for moving data from the non-refresh area to a refresh area of the memory, and generating a source-to-destination mapping table accordingly, wherein when the memory is switched to a lower power consumption state, the refresh area is refreshed and the non-refresh area is not refreshed; and performing a first data movement to move data from the non-refresh area to the refresh area according to the source-to-destination mapping table without using any program in the memory.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a DRAM with continuous pages;

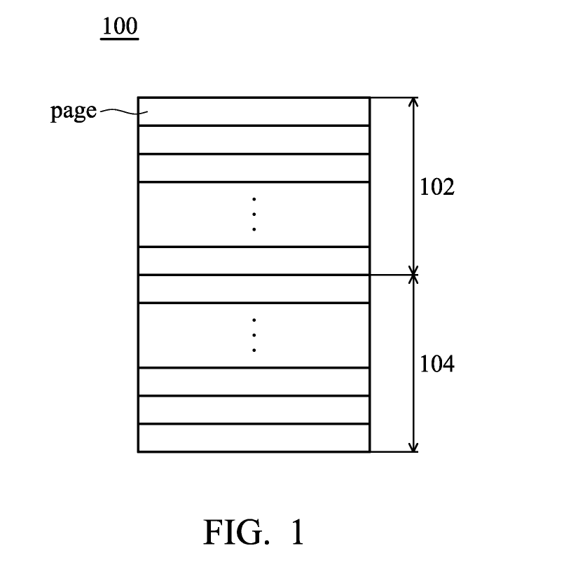

FIG. 2 shows a block diagram depicting a electronic device equipped with a data movement engine according to an exemplary embodiment of the invention;

FIG. 3 shows a flow chart depicting an exemplary embodiment of the invention when the electronic device 200 is being switched to a lower power consumption mode;

FIG. 4 shows a flow chart depicting an exemplary embodiment of the invention when a resume event occurs to wake up the electronic device 200;

FIG. 5A depicts an exemplary embodiment of the first data movement of step S318 of FIG. 3; and

FIG. 5B depicts another exemplary embodiment of the first data movement of step S318 of FIG. 3 when the DRAM 210 is implemented by a plurality of DRAMs.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

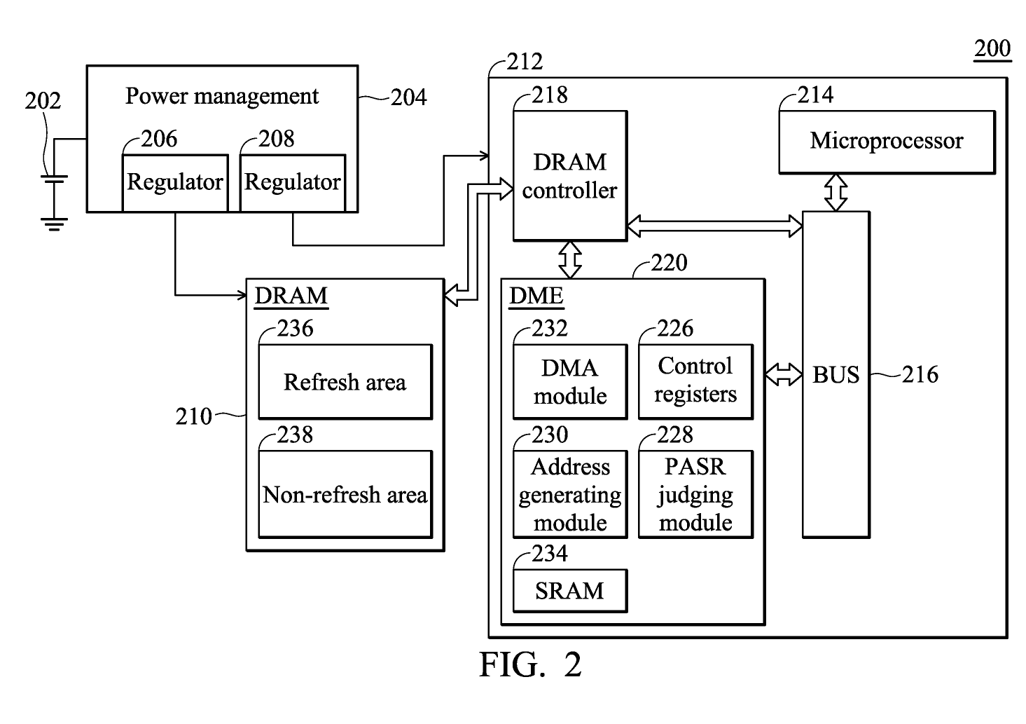

FIG. 2 shows a block diagram depicting an electronic device equipped with a data movement engine according to an exemplary embodiment of the invention. The electronic device 200 may be powered by a battery 202. In other embodiments, the electronic device 200 may be powered by a power supply. The energy provided by the battery 202 or a power supply could be regulated by a power management integrated-circuit (IC) 204, and the regulators 206 and 208 of the power management IC 204 are operative to power a dynamic random access memory (DRAM) 210 and block 212 (including other components of the electronic device 200), respectively. In block 212, there are a microprocessor 214, a bus 216, a DRAM controller 218 and a data movement engine (DME) 220.

The DME 220 may be realized by hardware or a computing system comprising a processor, which can be a miniature processor, executing software. When the electronic device 200 is in a normal mode, the microprocessor 214 accesses the DRAM 210 through the bus 216 and the DRAM controller 218. The DME 220 could be designed to substitute the microprocessor 214 to control the DRAM 210 when the electronic device 200 is switched between a normal mode and a lower power consumption mode (here lower power consumption mode could be any modes consuming less power than normal mode and can be pre-programmed by software according to the performance requirement for power consumption and the resume time). Note that the data movement performed before switching the DRAM 210 to a lower power consumption state and/or after resuming the DRAM 210 from the lower power consumption state is performed by the DME 220 rather than by the microprocessor 214. In comparison with conventional techniques in which the system kernel stored in the DRAM comprises data movement programs for PASR procedures, the DME 220 accomplishes the data movement without using any programs stored in the DRAM 210. The data movement ability is accomplished by the components in the DME 220. Because the DME 220 performs the data movement without using the programs in the DRAM 210, the data movement speed can be considerably improved. Furthermore, because the DRAM 210 does not have to reserve a space for said data movement programs, the contained data of the DRAM 210 is dramatically reduced and it increases the probability of switching the DRAM 210 to the PASR state for lower power consumption. Compared with conventional techniques, the DME 220 dramatically speeds up switching between the normal mode and the lower power consumption mode as well as reduces power consumption of the electronic device.

Furthermore, the DRAM 210 shown in FIG. 2 may be implemented by a plurality of DRAMs. At least a portion of one of the plurality of DRAMs may operate as the non-refresh area 238 while the remainder may operate as the refresh area 236. In such embodiments, when the DRAMs are in the lower power consumption state (here lower power consumption state could be any states consuming less power than normal mode and can be pre-programmed by software according to the performance requirement for power consumption and the resume time), the portion operating as the refresh area 236 is refreshed, and no refresh action is performed on the portion operating as the non-refresh area 238. No matter single DRAM or more than one DRAM, the volume of the refresh area 236 and the volume of the non-refresh area 238 can be adjusted.

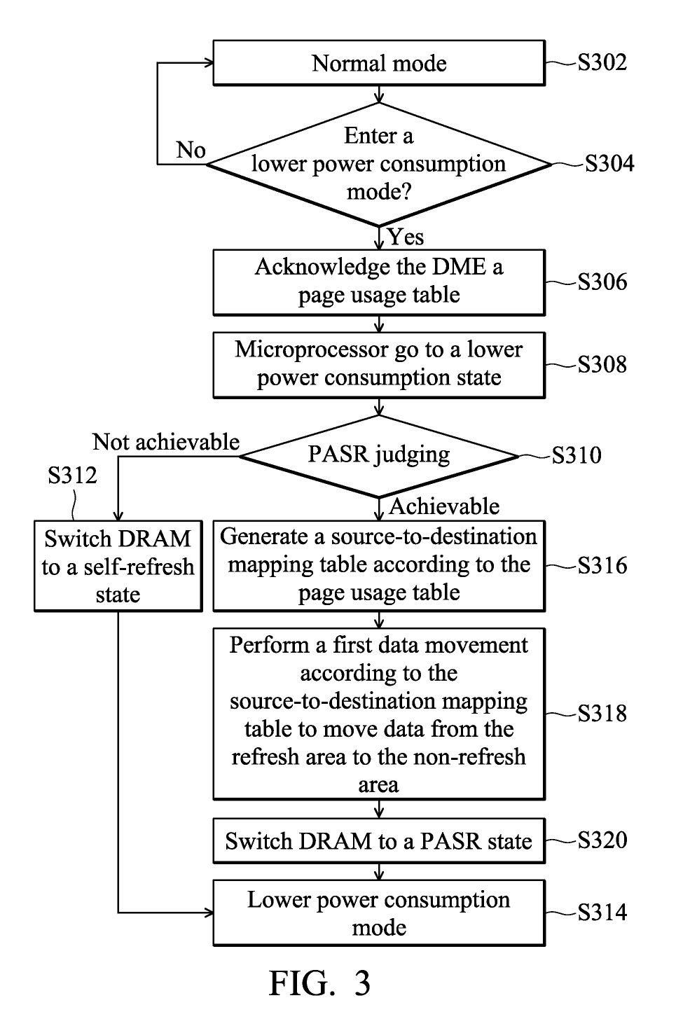

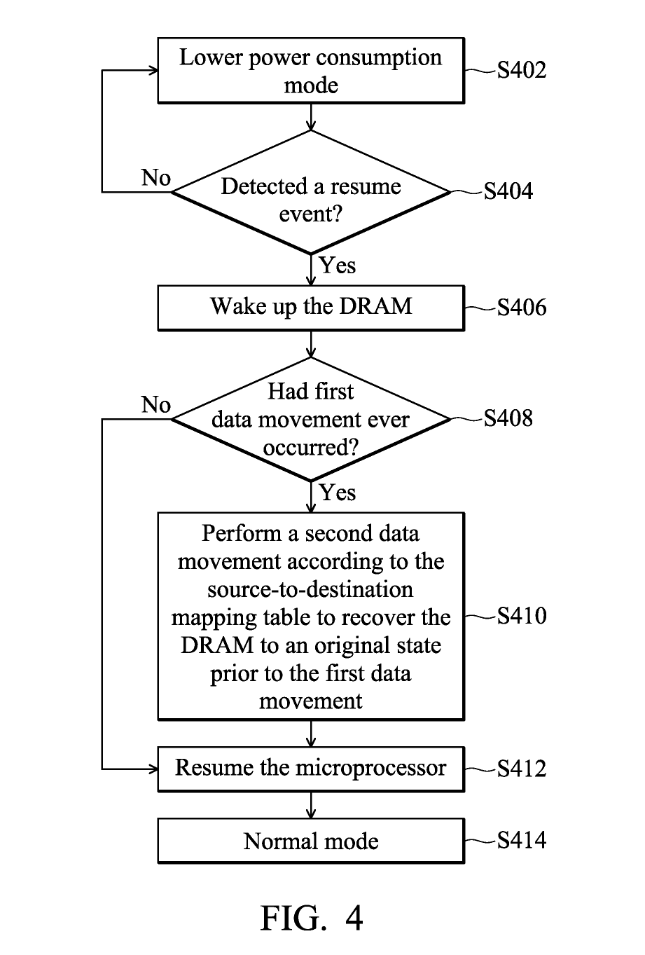

In the embodiment shown in FIG. 2, the DME 220 may include control registers 226, a PASR judging module 228, an address generating module 230 and a direct memory access (DMA) module 232, and a static random access memory (SRAM) 234. The control registers 226, PASR judging module 228 and the SRAM 234 are optional. The address generating module 230 and the DMA module 232 may be implemented by hardware or be accomplished by software of the computing system formed in the DME 220. The DME 220 may be coupled between the bus 216 and the DRAM controller 218. FIG. 3 shows a flowchart depicting the actions of the DME 220 when the electronic device 200 is being switched to a lower power consumption mode. FIG. 4 shows a flow chart depicting the actions of the DME 220 when a resume event occurs to wake up the electronic device 200.

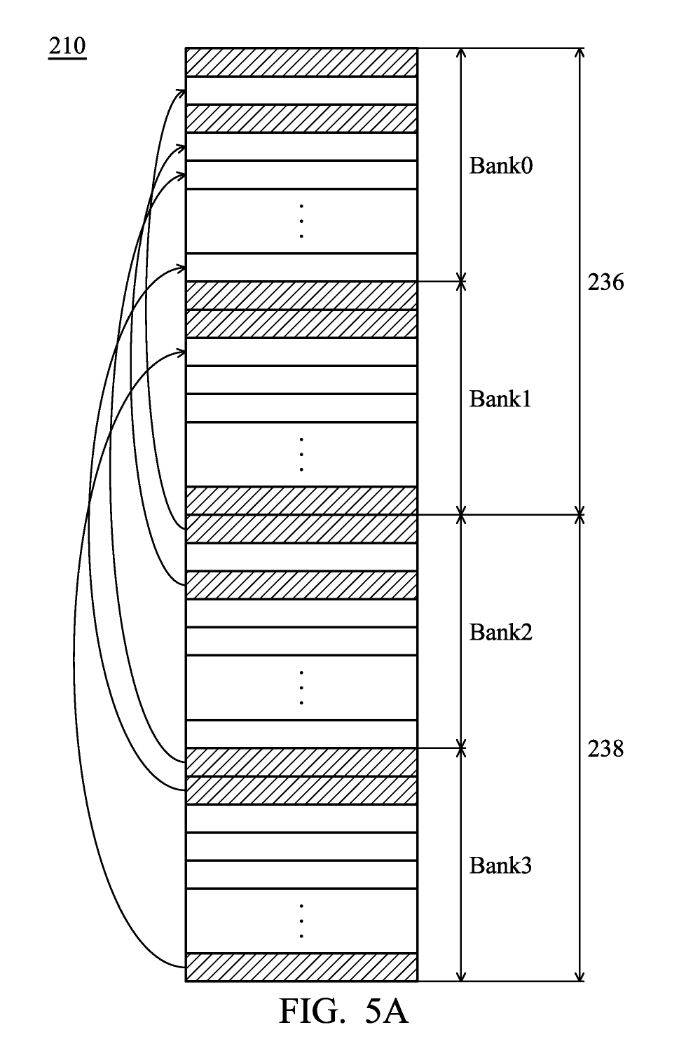

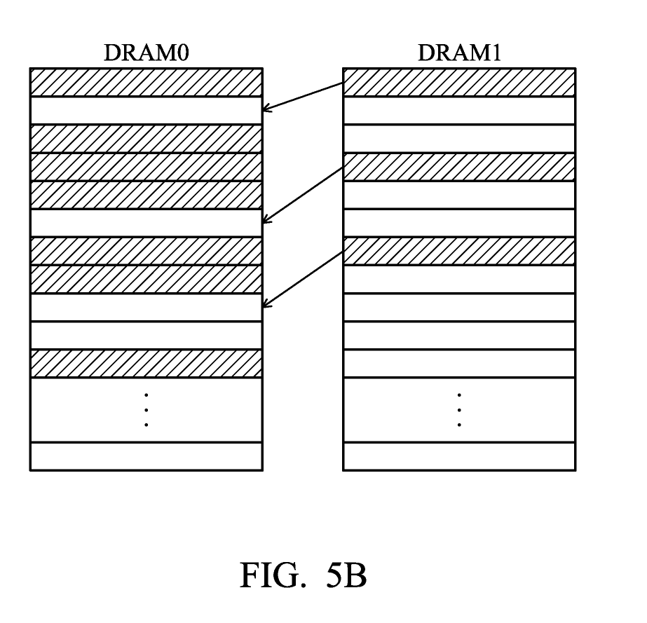

Referring to FIG. 3, the electronic device 200 is originally in a normal mode (S302). When step S304 judges that the electronic device 200 is being switched to a lower power consumption mode, a procedure S306 could be performed wherein the microprocessor 214 may execute software to set the control registers 226 of the DME 220 to indicate a location of a page usage table. The page usage table records used region (containing data) and unused region (free space) of the DRAM 210, and the microprocessor 214 may record the page usage table in a refresh area 236 of the DRAM 210 or in the SRAM 234 of the DME 220. After setting the control registers 226, the microprocessor 214 may be switched to a lower power consumption state, e.g. sleep or powered off, in step S308. Note that in other embodiments, the microprocessor 214 may still be active but does not intervene in the following data movement. In the following procedure, the DME 220 may replace the microprocessor 214 to access the DRAM 210. The microprocessor 214 would not access the data in DRAM 210 during the following data movement. In step S310, the PASR judging module 228 determines whether the DRAM 210 is suitable for the PASR state or further lower power consumption states such as deep power down (DPD) state, power off state, etc, wherein determination can be based on the page usage table indicated by the control registers 226. For example, the PASR judging module 228 may determine whether the unused region (free space) of the refresh area of the DRAM 210 is big enough for storing data in the non-refresh area of the DRAM 210. The DRAM 210 may be capable of entering the PASR state if the unused region of the refresh area of the DRAM 210 is big enough. In some embodiments, the PASR judging module 228 may determine whether there is unmovable data contained in a non-refresh area 238 of the DRAM 210. When the DRAM 210 is not suitable for the PASR state, step S312 is performed to switch the DRAM 210 to other lower power consumption states, such as self refresh state. Then the electronic device 200 could be switched to the lower power consumption mode in step S314. In some embodiments, a plurality of DRAMs is employed. The PASR judging module 228 may determine whether at least one of the DRAMs can enter the PASR state or further lower power consumption states such as deep power down (DPD) state, power off state, etc. If not, step S312 is performed to switch the at least one DRAM to other lower power consumption states, such as self-refresh state. Then the electronic device 200 could be switched to the lower power consumption mode in step S314. The determination can be based on the page usage table. For example, referring to FIG. 5B, if unused region of the refresh area of DRAM0 is big enough for storing data in the non-refresh area or even whole of DRAM1, DRAM1 may achieve PASR state or even DPD state.

When the PASR judging step S310 determines that the PASR can be applied in the DRAM 210, step S316 is performed. In step S316, the address generating module 230 looks up the page usage table according to the control registers to obtain at least one source address of data in the non-refresh area 238 of the DRAM 210 and generates at least one destination address for moving data from the non-refresh area 238 to the refresh area 236 of the DRAM 210. A source-to-destination mapping table is generated, accordingly. The source-to-destination mapping table may be stored in the refresh area 236 of the DRAM 210 or in the SRAM 234 of the DME 220. In step S318, DMA module 232 performs a first data movement to move data from the non-refresh area 238 to the refresh area 236 according to the source-to-destination mapping table. Note that the DMA module 232 allows the first data movement to be independent of the microprocessor 214. The data movement can be performed without using any program in the memory. The system kernel stored is the DRAM 210 does not include programs for moving data from the non-refresh area 238 to the refresh area 236. Thus, the system kernel on the DRAM 210 is movable because there may not be components accessing the kernel in this stage, therefore increasing the feasibility of the PASR technique. After the first data movement of step S318, the DME 220 switches the DRAM 210 to the PASR state in step S320 and then the electronic device 200 could be switched to the lower power consumption mode in step S314. During lower power consumption mode, though the microprocessor 214 and some components of the electronic device 200 may be in low powered state, the DME 220 and some components capable of detecting resume events could be awake. Furthermore, S314 could be optional, the electronic device 200 may not enter sleep mode after the data movement.

In another embodiment wherein the DME does not include a PASR judging module (228), the step S310 of FIG. 3 could be realized by the microprocessor 214 of FIG. 2 before the step S308 powers down the microprocessor 214.

This paragraph discusses the flowchart of FIG. 4. The electronic device 200 of FIG. 2 is originally in a lower power consumption mode (S402). When a resume event, for example, the key pad or touch screen is pressed by user, is detected in step S404, the flowchart enters the following steps. In step S406, the DRAM 210 leaves the lower power consumption state such as the self-refresh state, the PASR state, the DPD state, the power off state, etc, depending on the result of the PASR judging step S310 of FIG. 3. In step S408, when it is determined that the DME 220 has performed the first data movement (step S318 of FIG. 3) on the DRAM 210, step S410 is performed. In step S410, the DMA module 232 performs a second data movement according to the source-to-destination mapping table established in step S316, to move data at the recorded destination addresses back to the recorded source addresses. Thus, the DRAM 210 may recover to its original state prior to the first data movement. Also, the DMA module 232 performs the second data movement independently of the microprocessor 214. In one embodiment, the DMA module 232 performs the second data movement independently of the microprocessor 214 means the second data movement is performed without using the microprocessor 214. Besides, the data movement can be performed without using any program in the memory. The microprocessor 214 can be resumed later in step S412 to reduce more power consumption. However, step S412 may be optional if the microprocessor 214 didn't enter lower power consumption state. Finally, in step S414, the electronic device 200 is switched to the normal mode for normal operations. Referring back to step S408, when it is determined that the first data movement has not been performed on the DRAM 210, the microprocessor 214 may be resumed (step S412) without performing S410, and the electronic device 200 is switched to the normal mode in step S414.

FIG. 5A depicts an exemplary embodiment of the first data movement of step S318 of FIG. 3. In FIG. 5A, the DRAM 210 is illustrated by a plurality of continuous pages and the pages are divided into 4 banks, Bank0 . . . , Bank3 Bank0 and Bank1 form the refresh area 236 and Bank2 and Bank3 form the non-refresh area 238. The pages containing data (used region) are marked by oblique lines and the blank pages represent unused pages (unused region). The first data movement may move data from the non-refresh area 238 to the refresh area 236 as the arrows shown in this figure. After the first data movement, the DRAM 210 can be switched to the PASR state to reduce power consumption without losing any data.

In other embodiments, more than one DRAM may be applied in an electronic device. For example, the DRAM 210 of FIG. 2 may be replaced by two DRAMs, DRAM0 and DRAM1 shown in FIG. 5B. In such a case, DRAM0 may play the role of the refresh area 236 of the DRAM 210, and DRAM1 may perform as the non-refresh area 238 of the DRAM 210. The arrows shown in FIG. 5B indicate the first data movement performed to the DRAMs (DRAM0 and DRAM1) by the DMA 232. After the first data movement, the DRAM1 is blank and can be completely powered off to reduce the power consumption of the device 200.

It should be noted that, though DRAMs are employed in the embodiments above, this invention applies to other memories as well, such as SRAM, SDRAM, flash, etc. Besides, the orders of the steps shown in the embodiments above are illustrative only and not intended to be limitation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data movement engine for an electronic device, comprising:
an address generating module, obtaining at least one source address of data in a non-refresh area of a memory of the electronic device, and generating at least one destination address for moving data from the non-refresh area to a refresh area of the memory, wherein a source-to-destination mapping table is generated and, when the memory is switched to a lower power consumption state, the refresh area is refreshed and the non-refresh area is not refreshed; and
a direct memory access module, performing a first data movement to move data from the non-refresh area to the refresh area according to the source-to-destination mapping table and independently of a microprocessor of the electronic device.

2. The data movement engine as claimed in claim 1, further comprising:
control registers, set by the microprocessor to indicate a location of a page usage table, wherein the page usage table records used region and unused region of the memory;
wherein the address generating module looks up the page usage table to obtain the at least one source address of the data in the non-refresh area.

3. The data movement engine as claimed in claim 1, realized by hardware or a computing system comprising a processor executing software.

4. The data movement engine as claimed in claim 1, wherein the direct memory access module performs the first data movement before the memory is switched to the lower power consumption state and performs a second data movement after the memory leaves the lower power consumption state, and the second data movement is performed according to the source-to-destination mapping table and independently of the microprocessor to recover the memory to an original state prior to the first data movement.

5. The data movement engine as claimed in claim 1, wherein the memory is implemented by at least one dynamic random access memory (DRAM).

6. The data movement engine as claimed in claim 5, wherein the lower power consumption state is a partial-array-self-refresh (PASR) state.

7. The data movement engine as claimed in claim 1, wherein the memory is implemented by a plurality of dynamic random access memories (DRAMs), at least a portion of one of the plurality of DRAMs is not refreshed for the lower power consumption state.

8. The data movement engine as claimed in claim 6, wherein the DRAM is waken up from the PASR state when a resume event occurs.

9. The data movement engine as claimed in claim 8, wherein, after the DRAM is waken up from the PASR state, the direct memory access module performs a second data movement, according to the source-to-destination mapping table and independently of the microprocessor, to recover the DRAM to an original state prior to the first data movement.

10. The data movement engine as claimed in claim 5, further comprising:
a partial-array-self-refresh (PASR) judging module, determining whether a PASR state for the DRAM is achievable according to a page usage table, the page usage table recording used region and unused region of the DRAM;
wherein:
when the PASR state is determined to be achievable, the source-to-destination mapping table is generated, the direct memory access module performs the first data movement and then the data movement engine switches the DRAM to the PASR state.

11. The data movement engine as claimed in claim 2, further comprising a static random access memory (SRAM) for storing at least one of the page usage table and the source-to-destination mapping table.

12. The electronic device as claimed in claim 2, wherein at least one of the page usage table and the source-to-destination mapping table is stored in the refresh area of the memory.

13. A method of controlling a memory of an electronic device, comprising:
obtaining at least one source address of data in a non-refresh area of the memory and generating at least one destination address for moving data from the non-refresh area to a refresh area of the memory, and generating a source-to-destination mapping table accordingly, wherein when the memory is switched to a lower power consumption state, the refresh area is refreshed and the non-refresh area is not refreshed; and
performing a first data movement to move data from the non-refresh area to the refresh area according to the source-to-destination mapping table without using any program in the memory.

14. The method as claimed in claim 13, further comprising:
providing control registers to be set by a microprocessor of the electronic device to indicate a location of a page usage table, wherein the page usage table records used region and unused region of the memory; and
looking up the page usage table to obtain the at least one source address of the data in the non-refresh area of the memory.

15. The method as claimed in claim 13, further comprising:
performing a second data movement after the memory leaves the lower power consumption sate, wherein the second data movement is performed according to the source-to-destination mapping table without using any program in the memory, and is operative to recover the memory to an original state prior to the first data movement.

16. The method as claimed in claim 13, wherein the memory is implemented by at least one dynamic random access memory (DRAM).

17. The method as claimed in claim 16, wherein the lower power consumption state is a partial-array-self-refresh (PASR) state.

18. The method as claimed in claim 17, further comprising waking up the DRAM from the PASR state when a resume event occurs.

19. The method as claimed in claim 18, further comprising performing a second data movement after waking up the DRAM from the PASR state, wherein the second data movement, performed according to the source-to-destination mapping table and without using any program in the DRAM, recovers the DRAM to an original state prior to the first data movement.

20. The method as claimed in claim 16, further comprising:
determining whether a PASR state for the DRAM is achievable according to a page usage table, the page usage table recording used region and unused region of the DRAM;
wherein when the PASR state for the DRAM is determined to be achievable, switching the DRAM to the PASR state after the steps of generating the source-to-destination mapping table and the first data movement are accomplished.

21. The method as claimed in claim 14, further providing a static random access memory (SRAM) for storing at least one of the page usage table and the source-to-destination mapping table.

22. The method as claimed in claim 14, wherein at least one of the page usage table and the source-to-destination mapping table is stored in the refresh area of the memory.
